(19) United States
(12) Patent Application Publication
(10) Pub. No.: US 2025/0371181 A1
(43) Pub. Date: Dec. 4, 2025

(54) SYSTEMS AND METHODS FOR TRACKING USER REQUESTED MODIFICATIONS TO DATA FOR DATATYPE AND FILE MANAGEMENT

(71) Applicant: Truist Bank, Charlotte, NC (US)

(72) Inventors: Hope Noelle Astle, Mint Hill, NC (US); Sarah Anne Massagee, Decatur, GA (US); Joel Andrew Viray Baker, Spring Valley, CA (US); Jennifer Meredith Merten, Brookhaven, GA (US); Erik Schutzman, Fort Mill, SC (US); Michael Joseph Draper, Longview, WA (US); Adam Richard Rogers, Atlanta, GA (US); Katlyn Jillisa Carrion, Cornelius, NC (US)

(73) Assignee: Truist Bank, Charlotte, NC (US)

(21) Appl. No.: 18/887,566

(22) Filed: Sep. 17, 2024

Related U.S. Application Data
(60) Provisional application No. 63/654,490, filed on May 31, 2024.

(51) Int. Cl. G06F 21/62

(52) U.S. Cl. CPC G06F 21/6218

(57) ABSTRACT

Systems and methods for tracking user requested modifications to data for data type and file management, the system is configured to receive, from a computing device, a first data communication requesting user data associated with a first user profile that indicates one or more requested modifications to the first user profile. The system determines, via a database storing data of a plurality of user profiles, modification attribute data associated with the first user profile. The system transmits, to the computing device, a second data communication that indicates the modification attribute data associated with the first user profile.

### PRIORITY

This application is a Non-Provisional Application claiming priority to Provisional Application No. 63/654,490, entitled SYSTEMS AND METHODS FOR TRACKING USER REQUESTED MODIFICATIONS TO DATA filed on May 31, 2024, which is herein incorporated by reference in its entirety.

### FIELD OF THE INVENTION

This invention relates generally to the field of tracking and accessing user data, and more particularly embodiments of the invention relate to tracking user requested modifications to data.

### BACKGROUND OF THE INVENTION

Accessing information associated with a user profile is important for users to ascertain the status of the user profile, particularly if the user submitted a request that an action be taken, or a modification occur, regarding the user profile. For example, the user could request that an entity take a specific action regarding the user profile. However, the company may not be able to provide specific information directly to the user regarding the status of the request due to regulations that apply to the type of user profile or the entity. A need exists to allow entities to implement a system that provides updates regarding requests for an action to be taken, or a modification occur, on a user profile.

### BRIEF SUMMARY

Shortcomings of the prior art are overcome and additional advantages are provided through the provision of a computing system for tracking user requested modifications to data. The system includes, for instance, at least one processor; a communication interface communicatively coupled to the at least one processor; and a memory device storing executable code that, when executed, causes the at least one processor to: receive, from a computing device, a first data communication for user data associated with a first user profile; confirm, based on data associated with the first data communication, the computing device is allowed to access data associated with the first user profile; determine, via a database storing data associated with a plurality of user profiles, modification attribute data associated with the first user profile; and transmit, to the computing device, a second data communication that indicates the modification attribute data associated with the first user profile. The computing device can be configured to provide the modification attribute data to the user of the computing device. The modification attribute data indicates a status of the one or more modifications to the first user profile, and, the user data indicates one or more modifications to the first user profile. The modification attribute data indicates one or more of a transaction date, a status progress, an account identifier, a request identifier, a description of the modification, a transaction amount, a request date, and/or a completion date. The first user profile can be associated with a resource enterprise, and the action to be taken on the first user profile comprises the resource enterprise modifying a resource value associated with the first user profile. A portion of the modification attribute data associated with the first user profile can have data that the user is not allowed to access, and the resource enterprise is allowed to access the portion of the modification attribute data.

In an embodiment, the memory device storing executable code that, when executed, further causes the at least one processor to: determine, based on a third data communication indicating an update to the modification attribute data associated with the first user profile, that a first status of a first modification of the one or more modifications has changed to a second status of the first modification; update the database storing data associated with the plurality of user profiles to indicate the change from the first status to the second status; and transmit, to the computing device, a fourth data communication indicating the second status of the first modification.

In an embodiment, the memory device storing executable code that, when executed, further causes the at least one processor to: determine, via the database storing data associated with the plurality of user profiles, modification attribute data associated with the second user profile. The modification attribute data indicates a status of one or more modifications to the second user profile, and the second data communication indicates the modification attribute data associated with the second user profile. The first data communication for user data associated with the first user profile further comprises user data associated with a second user profile.

In an embodiment, the computing device is configured to provide the modification attribute data to the user of the computing device is further configured to: determine, based on the modification attribute data associated with the first user account, a graphical user interface (GUI) configured to display the modification attribute data associated with the first user profile; and cause the GUI to be displayed on the computing device.

Additionally, disclosed herein is a computing system for tracking user requested modifications to data. The system includes, for instance, at least one processor; a communication interface communicatively coupled to the at least one processor; and a memory device storing executable code that, when executed, causes the at least one processor to: transmit, from a computing device, a first data communication for user data associated with a first user profile, wherein the user data indicates one or more modifications to the first user profile, wherein the first data communications causes a determination, via a database storing data associated with a plurality of user profiles, of modification attribute data associated with the first user profile, wherein the modification attribute data indicates a status of the one or more modifications to the first user profile; and receive, by the computing device, a second data communication that indicates the modification attribute data associated with the first user profile, wherein the computing device is configured to provide the modification attribute data to the user of the computing device. The modification attribute data indicates one or more of a transaction date, a status progress, an account identifier, a request identifier, a description of the modification, a transaction amount, a request date, and/or a completion date.

In an embodiment, the memory device storing executable code that, when executed, further causes the at least one processor to: receive, by the computing device, a third data communication indicating an update to the modification attribute data associated with the first user profile from a first status to a second status.

In an embodiment, the memory device storing executable code that, when executed, further causes the at least one processor to: receive, by the computing device, modification attribute data associated with the second user profile. The modification attribute data indicates a status of one or more modifications to the second user profile, and the second data communication indicates the modification attribute data associated with the second user profile.

In an embodiment, the memory device storing executable code that, when executed, further causes the at least one processor to: determine, based on the modification attribute data associated with the first user account, a graphical user interface (GUI) configured to display the modification attribute data associated with the first user profile; and cause the GUI to be displayed on the computing device.

In an embodiment, the first user profile is associated with a resource enterprise, and the action to be taken on the first user profile comprises the resource enterprise modifying a resource value associated with the first user profile.

In an embodiment, a portion of the modification attribute data associated with the first user profile comprises data that the user is not allowed to access, and the resource enterprise is allowed to access the portion of the modification attribute data.

Also disclosed herein is a computer-implemented method for tracking user requested modifications to data. The method includes receiving, from a computing device, a first data communication for user data associated with a first user profile; confirming, based on data associated with the first data communication, the computing device is allowed to access data associated with the first user profile; determining, via a database storing data associated with a plurality of user profiles, modification attribute data associated with the first user profile; and transmitting, to the computing device, a second data communication that indicates the modification attribute data associated with the first user profile. The computing device can be configured to provide the modification attribute data to the user of the computing device. The user data indicates one or more modifications to the first user profile, and the modification attribute data indicates a status of the one or more modifications to the first user profile.

In an embodiment, the computer implemented method further includes determining, based on a third data communication indicating an update to the modification attribute data associated with the first user profile, that a first status of a first modification of the one or more modifications has changed to a second status of the first modification; updating the database storing data associated with the plurality of user profiles to indicate the change from the first status to the second status; and transmitting, to the computing device, a fourth data communication indicating the second status of the first modification.

In an embodiment, the computer implemented method further includes determining, via the database storing data associated with the plurality of user profiles, modification attribute data associated with the second user profile. The modification attribute data indicates a status of one or more modifications to the second user profile, and the second data communication indicates the modification attribute data associated with the second user profile.

In an embodiment, the computer implemented method further includes determining, based on the modification attribute data associated with the first user account, a graphical user interface (GUI) configured to display the modification attribute data associated with the first user profile; and cause the GUI to be displayed on the computing device.

In an embodiment, the modification attribute data indicates one or more of a transaction date, a status progress, an account identifier, a request identifier, a description of the modification, a transaction amount, a request date, and/or a completion date.

In an embodiment, the first user profile is associated with a resource enterprise, and the action to be taken on the first user profile comprises the resource enterprise modifying a resource value associated with the first user profile.

The features, functions, and advantages that have been described herein may be achieved independently in various embodiments of the present invention including computer- implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an enterprise system, and environment thereof, in accordance with an embodiment of the present invention;

FIG. 2 is a diagram of a data structure, according to at least one embodiment, utilized in machine learning;

FIG. 3 is a diagram of a graphical user interface associated with a user requesting modification to user data associated with an account;

FIG. 4 is a diagram of a graphical user interface associated with a user requesting modification to user data associated with an account;

FIG. 5 is a diagram of a graphical user interface associated with a user searching modification requests associated with an account;

FIG. 6 is a diagram of a graphical user interface associated with a user requesting modification to user data associated with an account;

FIG. 7 is a diagram of a graphical user interface associated with a user requesting modification to user data associated with an account;

FIG. 8 is a diagram of a graphical user interface associated with a user searching modification requests associated with an account; and

FIG. 9 is a flow chart representing a method, according to at least one embodiment, of accessing user data.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Like numbers refer to like elements throughout. Unless defined otherwise, technical and scientific terms used herein have the same meaning as commonly understood to one of ordinary skill in the art to which the presently disclosed subject matter pertains.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Furthermore, a device or structure that is configured in a certain way is configured in at least that way, but may also be configured in ways that are not listed.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements, but is not limited to possessing only those one or more steps or elements.

The terms “couple,” “coupled,” “connected,” and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

As used herein, the terms “enterprise” or “provider” generally describes a person or business enterprise (e.g., company, organization, institution, business, university, etc.) that hosts, maintains, or uses computer systems that provide functionality for the disclosed systems and methods. The term “enterprise” may generally describe a person or business enterprise providing goods and/or services. Interactions between an enterprise system and a user device can be implemented as an interaction between a computing system of the enterprise and a user device of a user. For instance, user(s) may provide various inputs that can be interpreted and analyzed using processing systems of the user device and/or processing systems of the enterprise system. Further, the enterprise computing system and the user device may be in communication via a network. According to various embodiments, the enterprise system and/or user device(s) may also be in communication with an external or third-party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein with reference to flowchart illustrations and/or block diagrams of computer-implemented method(s) and computing system(s). Each block or combinations of blocks of the flowchart illustrations and/or block diagrams can be implemented by computer readable program instructions or code that may be provided to a processor of a general purpose computer, special purpose computer, programmable data processing apparatus or apparatuses (the term “apparatus” includes systems and computer program products), and/or other device(s). In particular, the computer readable program instructions, which can be executed via the processor of the computer, programmable data processing apparatus, and/or other device(s), create a means for implementing the functions/acts specified in the flowchart and/or block diagram block(s).

In one embodiment, computer readable program instructions may also be stored in one or more computer-readable storage media that can direct a computer, programmable data processing apparatus, and/or other device(s) to function in a particular manner such that a computer readable storage medium of the one or more computer-readable storage media having instructions stored therein comprises an article of manufacture that includes the computer readable program instructions, which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block(s). Additionally, or alternatively, these computer program instructions may be stored in a computer-readable memory that can direct a computer, programmable data processing apparatus, and/or other device(s) to function in a particular manner such that the instructions stored in the computer readable memory produce an article of manufacture that includes the computer readable program instructions, which implement the function/act specified in the flowchart and/or block diagram block(s). In some embodiments, computer-implemented steps/acts may be performed in combination with operator/human implemented steps/acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable computer readable program instructions for implementing the specified logical function(s). Similarly, alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, and/or the functions of the blocks may sometimes be executed in the reverse order, depending upon the functionality involved.

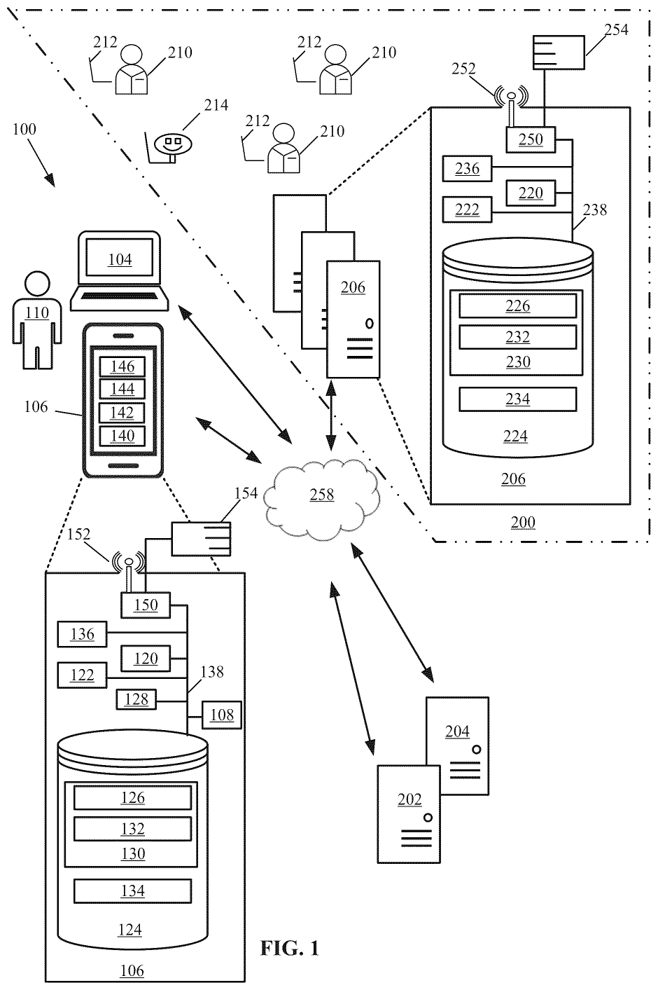

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally, or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)-with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subject matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The computing system 206 can be configured to receive, from a user device (e.g., user device 104, user device 106, etc.), a first data communication requesting user data associated with a first user profile. The user device can send the data communication via the network 258 to the computing system 206. The user profile can be associated with the enterprise system 200. The user profile can be stored in the computing system 206 or a database associated with the computing system 206. The user data can indicate one or more modifications requested by the user to the user profile. For example, the user associated with the user profile can determine that there is an error with the data associated with the user profile. The user can request that the data be modified to rectify the error. For example, the user profile can be one or more accounts associated with a resource enterprise. The user may determine there was an incorrect action taken on the accounts, such as an overcharge, a fraudulent charge, an improper credit, and/or any actions that can be associated with an account. The user can request a modification to the user profile to correct the error. The computing system 206 can process the request to modify the user profile and store data associated with the request (e.g., the storage device 224 associated with the computing system 206, or another computing system 206 in the enterprise system 200).

The user profile can have one or more attributes associated with the user profile. The one or more attributes associated with the user profile can be stored in data that reflects the one or more attributes associated with the user profile. For example, the one or more attributes can indicate demographic information of users associated with the user profile, rewards for users associated with the user profile, accounts associated with the one or more users, requested modifications to the user profile, or any data that can be associated with a user and a user profile.

The computing system 206 can be configured to confirm, based on authentication data associated with the first data communication, the user device is authorized to access data associated with the user profile. For example, the first data communication can include a password and/or username associated with the user profile. The computing system 206 can be configured to compare the provided password and/or username to a database containing information associated with user profile to determine whether the provided password and/or username is valid or associated with the user profile. The computing system 206 can be configured to authenticate the password and/or username.

The computing system 206 can be configured to determine, via a database storing data of a plurality of user, modification attribute data associated with the user profile. The computing system 206 can query the database for data associated with the user profile. The database can provide the computing system 206 the requested data. The modification attribute data can indicate a status of one or more modifications to the user profile that the user requested. The data can indicate data associated with a specific transaction, a status of the modification request, account data, data associated with the request, and modification data that indicates any modifications that have occurred with the data. For example, the modification attribute data can indicate the transaction date of a specific transaction associated with the user profile, a status of the requested modification (e.g., in progress, action requested, credit issued, completed, etc.), the account associated with the modification request, a claim number associated with the modification request, a description of the transaction, and an amount of the transaction.

The computing system 206 can be configured to transmit to the user devices 104, 106, a second data communication that indicates the modification attribute data associated with the user profile. The user devices 104, 106 can be configured to provide the first user profile attribute data to a user of the user device. For example, the computing system 206 can transmit a data packet that indicates the modification attribute data associated with a requested change and/or modification to the user profile, and the user devices 104, 106 can be configured to convert the data into a graphical user interface to be displayed on a display associated with the user devices 104, 106.

The computing system 206 can be configured to receive a third data communication indicating an update to the modification attribute data associated with the user profile. For example, the enterprise system 200 can determine that a status of the requested modification has changed. The change can occur based the enterprise system 200 receiving data from the user device 104, 106 that provided data requested by the enterprise system 200 to make a requested modification. For example, the enterprise system 200 may need to receive factual proof from the user that the requested modification was an error or not done by the user, such as through fraud or a technical glitch. The enterprise system 200 may receive the data from the user via a human agent 210 or through electronic means. The enterprise system 200 can update the status of the requested modification automatically after receiving the requested data (e.g., receipts, documentation, etc.). The enterprise system 200 may be required to verify the received data prior to making the requested modification and/or updating the status of the request.

The user device 104, 106 can be configured to provide data to the enterprise network 200 via the network 258. The user device 104, 106 can be configured to use an application associated with the enterprise system 200 to transmit a communication to the computing system 206. A user of the user device 104, 106 can utilize the user device 104, 106 to receive updates and/or check the status of the requested medication from the enterprise system 200.

The computing system 206 can be configured to update the user profile data associated with the user profile stored within the database to indicate the change in status of the modification attribute data. The computing system 206 can be configured to receive a communication (e.g., from the enterprise system 200, the user devices 104,106, etc.) and update the database to reflect the change in the status. The computing system 206 can rewrite the data within the database to indicate the new status or create a new data entry to indicate that the status has changed. For example, after the enterprise system 200 receives a request from the user of the user devices 104, 106, to make a modification to the user profile, the enterprise system 200 can establish a new modification request based on data received from the user and indicate the status as in progress to indicate to the user the request is received and being processed. If the enterprise system 200 needs additional documentation and requests that from the user, the enterprise system 200 can change the status from in progress to action requested to indicate that the user needs to take an action in order to further progress the request towards completion. The enterprise system 200 can transmit a communication to the user devices 104, 106, or via another delivery method such as by mail or telephonically, to indicate the change in status, as well as the documentation that is requested to proceed with making the requested modification. The enterprise system 200 can determine one or more user devices 104, 106 associated with a user and transmit a communication to each of the user devices 104, 106 associated with the user to ensure that the user receives the communication.

The computing system 206 can be configured to determine the status for one or more user profiles associated with the user. For example, the user profiles can be multiple accounts that are associated with the same user, such as a checking account or a savings account. Each account can have a respective user profile to keep the data for each of the accounts separate from one another. As an example, if a user has a first account and a second account, the first account can be associated with a first user profile, and the second account can be associated with a second user profile. The data between the first and second user profiles can be separate from one another, but also linked via the user such that the enterprise system 200 associated both of the user profiles with the single user. For example, the first user profile can have one modification request associated with it, while the second user profile has a different amount (e.g., more or less) of modification requests. This way, the enterprise system 200 is capable of monitoring requests for multiple user profiles (e.g., user accounts) that are associated with a user. The multiple user profiles may be associated with multiple users. For example, there may be one or more authorized users of a user profile, and the enterprise system 200 can maintain data associated with multiple users associated with one or more profiles.

The computing system 206 can be configured to prevent the user accessing and/or viewing certain data associated with user profile. For example, due to regulations (e.g., governmental regulations), the enterprise system 200 may be prevented from communicating certain data to the user. The computing system 206 can be configured to only allow the user access to specific data associated with a user profile. Stated differently, the computing system 206 can be configured to prevent the user from accessing data associated with the user profile. The computing system 206 can indicate to the user (e.g., via the user devices 104, 106) that the user needs to contact the resource enterprise using a different communication technique to receive additional information. These restrictions can be utilized to prevent unauthorized access to data stored within the enterprise system 200. For example, computing system 206 can provide general or basic information associated with a request, but not all of the data associated with the request, such as detailed transaction data. Stated differently, the computing system 206 can allow a user to track and/or monitor a modification request, but not allow the user to take any actions regarding the modification request, as well as not allow the user access to certain data associated with the modification request. As an example, if the user profile is a user account and the requested modification is for a credit or cancellation of a specific transaction, the computing system 206 can provide the user an overview of the progress of the request, without showing all of the backend data that is required for the enterprise system 200 to determine whether the requested modification is allowed (e.g., justified). In this manner, the computing system 206 can keep track of data for both the enterprise system 200 and the user profile, while only allowing the user access to some of the data associated with the user profile.

While the above description described specific function of the computing system 206, the enterprise system 200 can include the same capabilities of the computing system 206 since the enterprise system 200 can comprise a plurality of computing systems 206. The user device 104, 106 can be configured to operate in a similar manner to the computing system 206. That is, user device 104, 106 can be configured to determine the modification request data. The user profile information can be stored on the user device 104, 106 such that the user device can be configured to handle provide data regarding the user profile to the user. The user device 104, 106 may simply receive data from the computing system 206 and/or the enterprise system 200 indicating that an update has occurred with the requested modification, and the user device 104, 106 can store the data so that the user can access the data. Stated differently, the computing system 206 and/or enterprise system 200 pushes data notifications to the user devices 104, 106 regarding the requested modification without receiving a request from the user device 104, 106. Thus, the user of the user device 104, 106 can be informed in real-time as an update in the status of the requested modification occurs without having the request the information from the computing system 206 and/or the enterprise system 200.

In an embodiment, the user device 104, 106 can be configured to handle the majority of the processing associated with accessing the user profile and communicates any updates to the computing system 206 and/or enterprise system 200 such that the computing system 206 and/or enterprise system 200 updates an account associated with the user profile that the user device 104, 106 does not have access to. For example, the account may be an enterprise account associated with the enterprise system 200 that is separate and distinct from the user profile.

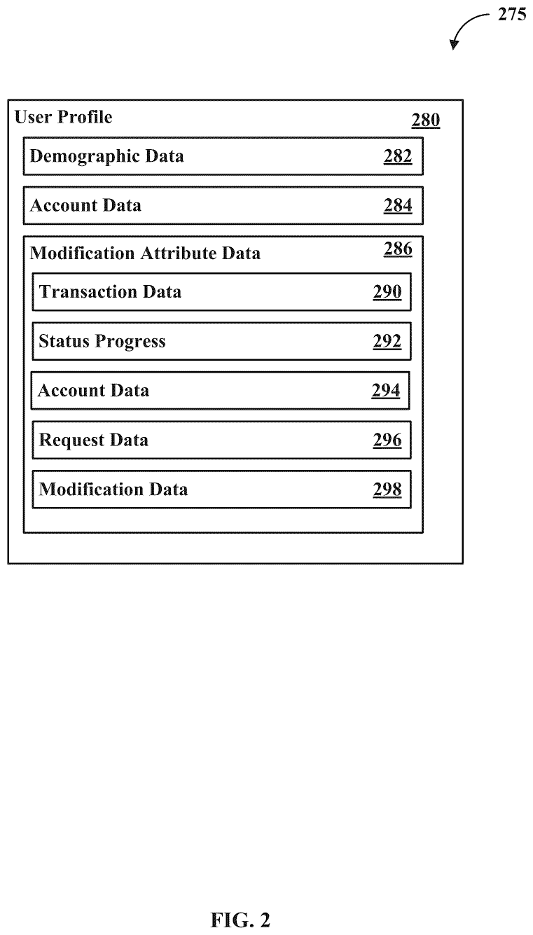

FIG. 2 is a diagram of a data structure 275. The data structure can be associated with (e.g., stored in, maintained by, etc.) the enterprise system 200 and/or the computing system 206. The data structure 275 has a user profile 280 stored within the data structure. The user profile 280 can be associated with one or more users. In an embodiment, the user profile 280 represents an account associated with the resource enterprise 200, and the data structure 275 comprises data associated with the user account. The data structure 275 can comprise data that a user associated with the user profile 280 is unable to access (e.g., is prevented from access the data). Stated differently, the data structure 275 can comprise data that only the enterprise system 200 and/or the computing device 206 are able to access. While a single user profile 280 is shown, multiple user profiles 280 can be stored within the data structure 275. Further, the data structure 275 can be one of a plurality of data structures 275 stored within a database (e.g., the computing system 206, the enterprise system 200, etc.). The data structure 275 can also be stored on a user device (e.g., the user devices 104, 106 of FIG. 1) such that the user device is able to access the data with the data structure 275. For example, the data structure 275 may be maintained in a server and/or database (e.g., the computing system 206 and/or resource enterprise 200 of FIG. 1), and the server and/or database provides the data structure to the user device via a data communication.

The user profile 280 comprises demographic data 282, account data 284, and modification attribute data 286. The demographic data 282 can include demographic data of the user associated with the user profile such as age, location, contact information, personal identifying information, or any information that is associated with the user. The account data 284 can include data of an account associated with the user. The account data 284 can indicate an account identifier, a status of the account (e.g., current balance), authorized users associated with the account, transactions associated with the account, general account information, etc.

The modification attribute data 286 comprises data associated with a modification that a user associated with the user profile 280 requested. The modification attribute data 286 comprises transaction data 290, status progress 292, account data 294, request data 296, and modification data 298. The transaction data 290 comprises data of one or more transactions associated with the user profile 280. The transaction data 290 can include a transaction date, a transaction amount, a transaction description, a party the transaction was completed with (e.g., the party that removed and/or added a resource to the account), and a transaction identifier. While not shown in FIG. 2, the account data 284 can include the transaction data 290 for all transactions associated with the user profile 280. In an embodiment, the transaction data 290 only includes transactions associated with a modification requested by a user associated with the user profile 280.

The status progress 292 can indicate a status of a modification requested by a user associated with the user profile 280. The status progress 292 can include multiple states, such as in progress, action requested, actions completed, documents received, provisional credit issued, and/or completed. An in-progress status can indicate that the requested modification was received by the resource enterprise (e.g., the enterprise system 200 of FIG. 1), and that the requested modification is being processed by the resource enterprise. The action requested status can indicate that the user needs to take one or more actions for the requested modification to proceed further. As an example, the action requested can indicate that the user needs to submit documentation or additional information to support the requested modification. The documents received status can indicate that one or more documents have been received by the user, but the documents have not yet been reviewed to confirm whether the documents support the requested modification. For example, the documents provided by the user may need to be reviewed (e.g., by a human agent 214, by the computing system 206, or by the enterprise system 200 of FIG. 1) to ensure the provided documents are sufficient (e.g., meet the requirements) to indicate that the action is completed. The actions completed status can indicate that the user has completed one or more actions that were required to progress the requested. The actions completed status can have a respective action associated with it such that each action has a separate status to indicate each respective actions status. For example, there can be three actions that are required for the user to take to progress the modification request, and the actions completed status can separately track each of the three actions and store that information within the data structure 275.

The provisional credit status can indicate that requested modification has been granted provisionally to the user. For example, if the enterprise system 200 of FIG. 1 determines that the modification requested by the user associated with the user profile 280 should be completed, the enterprise system 200 can provisionally complete the modification. This way, the user is able to promptly receive a resolution to the requested modification, while allowing the enterprise system 200 to verify and complete the requested modification on the backend. The completed status can indicate that the requested modification was completed, and any provisional actions previously taken, if any, are now completed and no longer provisional.

The account data 294 can comprise data associated with account information of the user associated with the user profile 280. The account data 294 can include an account identifier, a resource balance associated with the account, users associated with the account, an enterprise system associated with the account, and so forth. The request data 296 can indicate the request that the user associated with the user profile 280 is making. The request data 296 can include a request identifier (e.g., a claim number), a transaction associated with the request, an amount requested to be changed, a reason for the requested change, a date the request was made, an entity associated with the request (e.g., an entity other than the user associated with the user profile 280), and so forth. The modification data 298 can comprise data associated with the modification such as any modifications that occur to the user profile based on the request. That is, the modification data 298 can store any changes made to modification attribute data 286, the transaction data 290, the status progress 292, the account data 294, and/or the request data 296. Stated differently, the modification data 298 can be a changelog of all updates, changes, steps, and/or actions that modify the user profile 280 whether or not the changes are based on the requested modification.

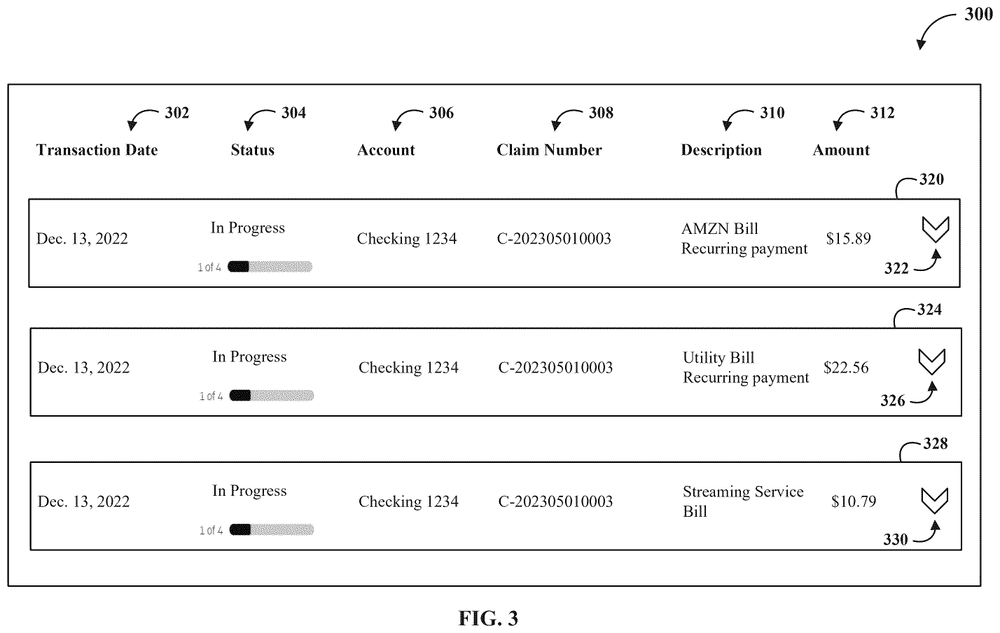

FIG. 3 is a diagram of a graphical user interface (GUI) 300 associated with a user requesting modification to user data associated with an account. The GUI 300 can be determined based on data (e.g., the data structure 275 of FIG. 2). The GUI 300 can be produced and/or provided by a computing device (e.g., the user devices 104, 106 and/or the computing system 206 of FIG. 1). The GUI 300 can be a graphical representation of the data structure 275 of FIG. 2 so that a user of a device (e.g., the user devices 104, 106 of FIG. 1) is able to comprehend data stored in the data structure 275. The GUI 300 can be displayed on display device associated with the computing device so that the user is capable of viewing the GUI 300.

The GUI 300 has columns for a transaction date 302, a status 304, an account 306, a claim number 308, a description 310, and an amount 312. The GUI 300 can display this information for one or more transactions 320, 324, and 328. For example, the transaction 320 has a transaction date 302 of December 13 2022, a status 304 of in progress, an account 306 of Checking 1234, a claim number 308 of C-202305010003, a description 310 of AMZN Bill Recurring payment, and an amount 312 of the transaction as $15.89. Each transaction 320, 324, and 328 can each have a respective graphical indicator 322, 326, 330 to indicate additional information can be viewed if the user interacts with the graphical indicator 322, 326, 330. While the graphical indicators 322, 326, and 330 are shown as a downward arrow, any shape and/or object can be used to indicate that a user can interact with the graphical indicators 322, 326, and 330.

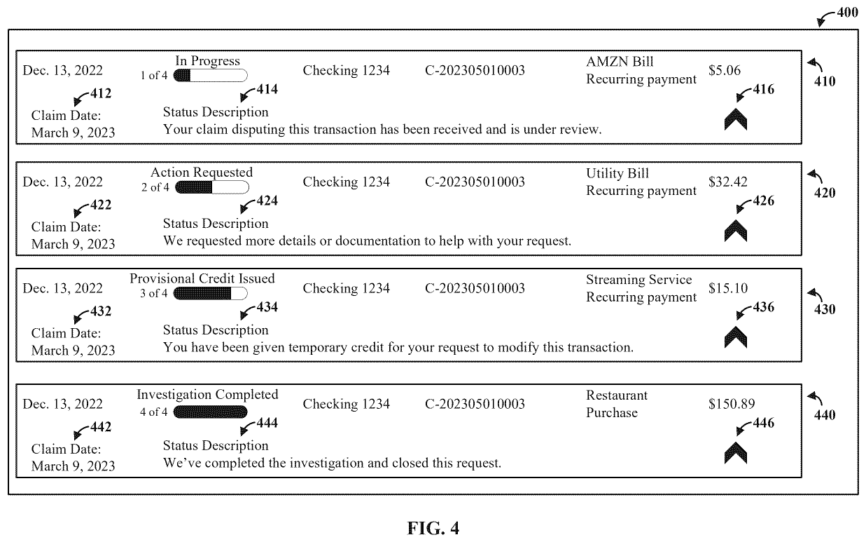

FIG. 4 is a diagram of a GUI 400 associated with a user requesting modification to user data associated with an account. The GUI 400 can be determined based on data (e.g., the data structure 275 of FIG. 2). The GUI 400 can be produced and/or provided by a computing device (e.g., the user devices 104, 106 and/or the computing system 206 of FIG. 1). The GUI 400 can be a graphical representation of the data structure 275 of FIG. 2 so that a user of a device (e.g., the user devices 104, 106 of FIG. 1) is able to comprehend data stored in the data structure 275. The GUI 400 can be displayed on display device associated with the computing device so that the user is capable of viewing the GUI 400.

The GUI 400 is similar to the GUI 300, but provides additional information to the user. The GUI 400 shows four transactions, 410, 420, 430, and 440. The graphical indicators 416, 426, 436, and 446 relate to the graphical indicators 322, 326, and 330 of FIG. 3, but have been modified (e.g., filled in and orientation shifted) to indicate that the user interacted with the graphical indicators. The transactions 410, 420, 430, and 440 can have respective claim dates 412, 422, 432, and 442 that indicate the date a claim was made (e.g., the date that the user requested modification to the user profile). The transactions 410, 420, 430, and 440 also provide more details regarding the respective status descriptions 414, 424, 434, and 444.

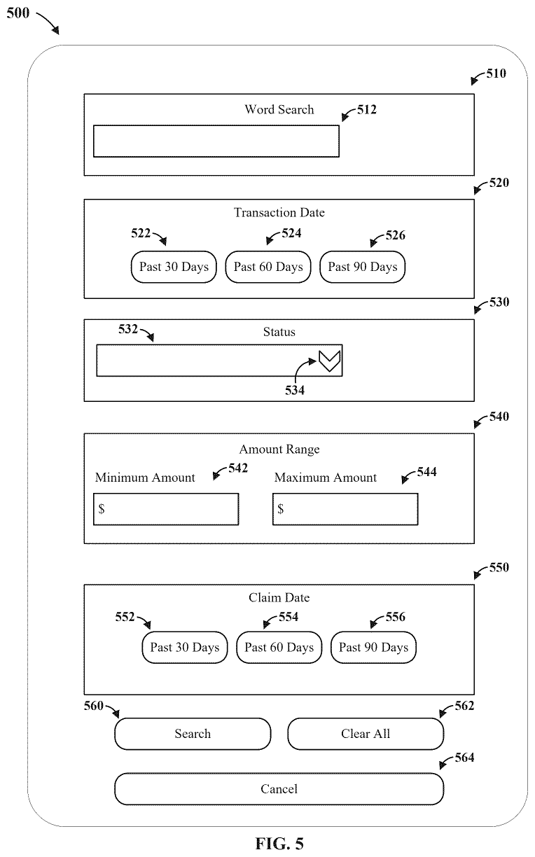

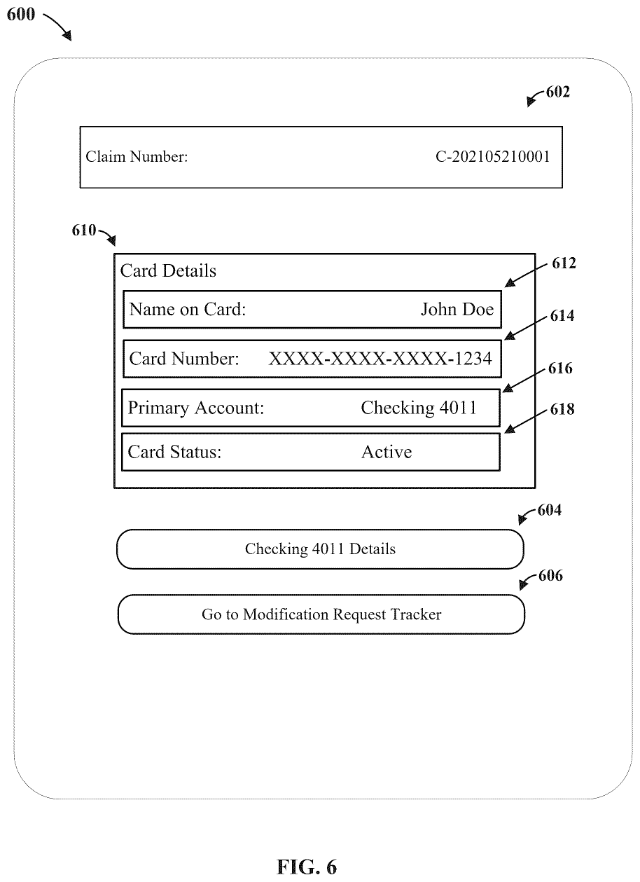

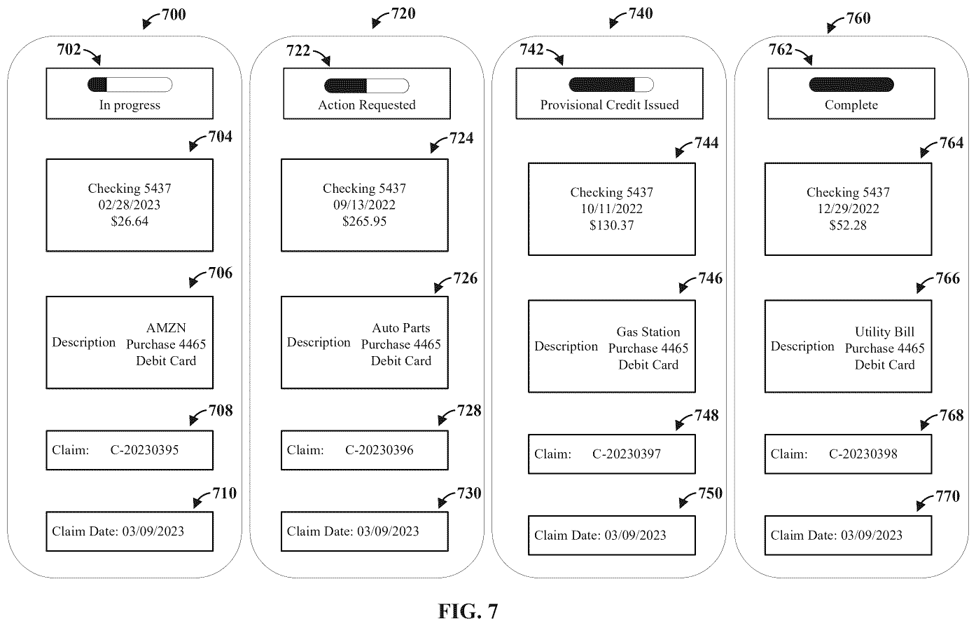

FIG. 5 is a diagram of a GUI 500 associated with a user searching modification requests associated with an account. The GUI 500 can be a graphical representation provided and/or displayed on a user device (e.g., the user devices 104, 106 of FIG. 1) that allows a user to interact with the GUI 500 to initiate a search of user profile. For example, the user can utilize GUI 500 to search for one or more transactions and/or requested modifications to a transaction associated with a user profile (e.g., the user profile 280 of FIG. 2). The search may generate another graphical user interface (e.g., GUI 300 of FIG. 3, GUI 400 of FIG. 4, GUI 600 of FIG. 6, and/or GUI 700 of FIG. 7) to provide the searched for information to the user.

The GUI 500 has a search graphical interaction 510. The search graphical interaction 510 can include a search box 512 that allows the user to provide search terms to search for. The GUI 500 has a transaction date graphical interaction 520. The transaction date graphical interaction 520 can indicate a plurality of dates that the user desires to search through to find one or more transactions associated with a specific date and/or date range. The user can select past 30 days 522, past 60 days 524, or past 90 days 526 for transactions that occurred in the aforementioned ranges. While specific ranges were provided, these are merely examples and any range, as well as the ability to receive an input from the user indicate a specific date, are contemplated by this disclosure.

The GUI 500 has a status graphical interaction 530. The status graphical interaction 530 can be represented as a drop down box 532 that the user can interact with to select from a variety of different statuses. The status graphical interaction 530 includes a graphical indicator 534 to indicate to the user that the user can view additional information by interacting with the graphical indicator 534. While a drop down box was described, this merely an example and the status graphical interaction 530 can include the ability to receive an input from the user indicate a specific status.

The GUI 500 has an amount graphical interaction 540. The amount graphical interaction 540 has a minimum amount 542 and a maximum amount 544 that the user can interact with to indicate a minimum, and maximum amount respectively, to search for. The user can interact with the minimum amount 542 and the maximum amount 544 to enter in a value for each if desired.

The GUI 500 has a claim date graphical interaction 550. The claim date graphical interaction 550 can indicate a plurality of dates that the user desires to search through for claims associated with the respective dates. The user can select past 30 days 552, past 60 days 554, or past 90 days 556 for claims and/or requests made in the aforementioned ranges. While specific ranges were provided, these are merely examples and any range, as well as the ability to receive an input from the user indicate a specific date, are contemplated by this disclosure.

The GUI 500 has a search graphical interaction 560, a clear all graphical interaction 562, and a cancel interaction 564. The search graphical interaction 560 can perform the search requested by the user based on the selected criteria (e.g., the search graphical interaction 510, the transaction date graphical interaction 520, the status graphical interaction 530, the amount graphical interaction 540, and/or the claim date graphical interaction 550). The search may be completed by one or more devices. For example, the user device (e.g., user device 104, 106 of FIG. 1) may communicate with a server and/or database (e.g., the computing system 206 and/or enterprise system 206) to provide the search data based on the selected graphical interactions. The server and/or database may search the server and/or database based on the search data and provide the results to the user device. Alternatively, the user device can be capable of performing the search without interacting with the server and/or database. The clear all graphical interaction 562 can clear (e.g., empty, remove, etc.) all of the selected criteria. That is, the clear all graphical interaction 562 can reset the GUI 500 for the user. The cancel graphical interaction 564 can cancel the search and return the user to a previous screen (e.g., closes out the GUI 500 and opens another graphical user interface).

FIG. 6 is a diagram of a GUI 600 associated with a user requesting modification to user data associated with an account. The GUI 600 has a claim number indicator 602. The claim number indicator 602 provides a user with a claim number (e.g., a modification request identifier). Each modification request identifier (e.g., claim number) can have a unique identifier. The GUI 600 has a card details graphic 610. The card details graphic 610 can provide details on a card (e.g., a debit card, credit card, electronic wallet, etc.) associated with the user profile to inform the user of the card's status. The card details graphic 610 indicates the name on the card 612, a card number 614 associated with the card, a primary account 616 associated with the card, and a card status 618. The GUI 600 also has graphical interactions to see more details 604 about the account associated with the card, as well as a graphical interaction to take the user to modification request tracker 606.

FIG. 7 is a diagram of a GUI 700, a GUI 720, a GUI 740, and a GUI 760 showing different modification requests at different stages. The GUI 700 shows a modification request status 702 of in progress. The GUIs 700, 720, 740, and 760 have a respective transaction graphical display 704, 724, 744, 764 that indicates data regarding the transaction. As shown, the transaction graphical displays 704, 724, 744, 764 show an account (e.g., user profile) identifier, a date the transaction occurred, and an amount of the transaction. The GUIs 700, 720, 740, and 760 show a respective description 706, 726, 746, 766 of the transaction that provides details regarding the transaction to the user. The GUIs 700, 720, 740, and 760 show a respective modification identifier 708, 728, 748, 768 that indicate an identifier associated the modification requested by the user. The GUIs 700, 720, 740, and 760 show a respective modification date 710, 730, 750, 770 that indicate a date that the user requested the modification. The GUIs 720, 740, and 760 are similar to GUI 700 except that the respective statuses 722, 742, and 762 are different. The GUI 720 has a status 722 of action requested. The action requested status 722 can indicate that the user needs to take one or more actions to proceed with the requested modification. The GUI 740 has a status 742 of provisional credit issued. The provisional credit issued status 742 can indicate that the user has received credit to the user profile (e.g., account). The GUI 760 has a status 762 of complete. The complete status 762 can indicate that the requested modification is completed.

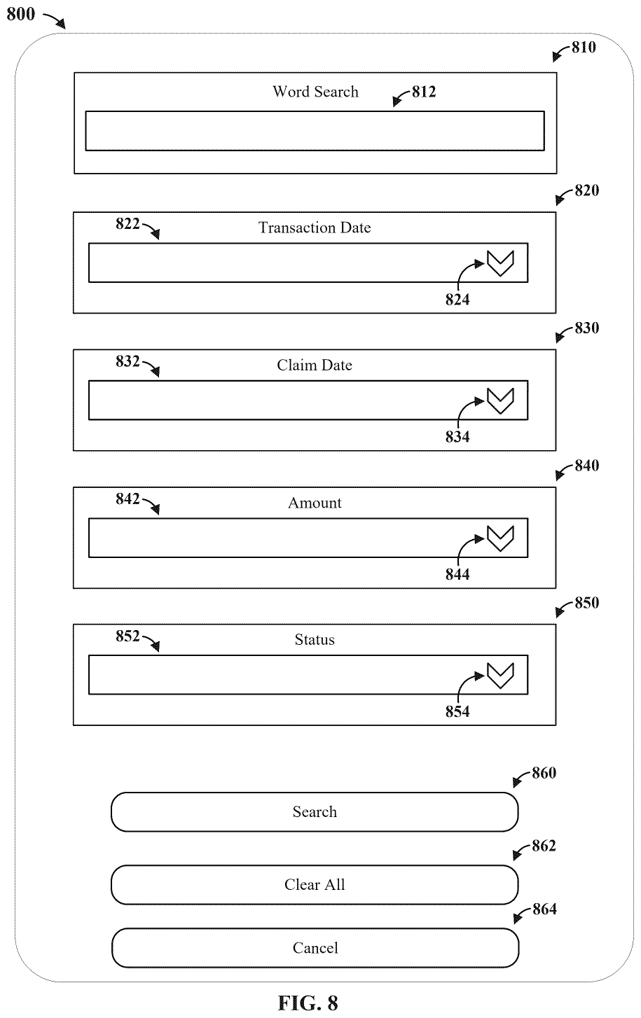

FIG. 8 is a diagram of a graphical user interface (GUI) 800 associated with a user searching modification requests associated with an account. The GUI 800 can be a graphical representation provided and/or displayed on a user device (e.g., the user devices 104, 106 of FIG. 1) that allows a user to interact with the GUI 800 to initiate a search of user profile. For example, the user can utilize GUI 800 to search for one or more transactions and/or requested modifications to a transaction associated with a user profile (e.g., the user profile 280 of FIG. 2). The search may generate another graphical user interface (e.g., GUI 300 of FIG. 3, GUI 400 of FIG. 4, GUI 600 of FIG. 6, and/or GUI 700 of FIG. 7) to provide the searched for information to the user.

The GUI 800 has a search graphical interaction 810. The search graphical interaction 810 can include a search box 812 that allows the user to provide search terms to search for. The GUI 800 has a transaction date graphical interaction 820. The transaction date graphical interaction 820 can indicate a plurality of dates that the user desires to search through to find one or more transactions associated with a specific date and/or date range. The user can interact with graphical interaction 824 to view a drop-down list of transaction dates to search. Alternative, the user can interact directly with the transaction date search 822 to enter a transaction date.

The GUI 800 has a claim date graphical interaction 830. The claim date graphical interaction 830 can be represented as a drop-down box 832 that the user can interact with to select from a variety of different statuses. The claim date graphical interaction 830 includes a graphical indicator 834 to indicate to the user that the user can view additional information by interacting with the graphical indicator 834. The user can interact with graphical indicator 834 to view a drop down list of claim dates to search. Alternative, the user can interact directly with the claim date search 832 to enter a transaction date.

The GUI 800 has an amount graphical interaction 840. The amount graphical interaction 840 can be represented as a drop-down box 842 that the user can interact with to select from a variety of different statuses. The amount graphical interaction 840 includes a graphical indicator 844 to indicate to the user that the user can view additional information by interacting with the graphical indicator 844. The user can interact with graphical indicator 834 to view a drop down list of amounts to search. Alternative, the user can interact directly with the amount search 842 to enter an amount.

The GUI 800 has a status graphical interaction 850. The status graphical interaction 850 can be represented as a drop-down box 852 that the user can interact with to select from a variety of different statuses. The status graphical interaction 850 includes a graphical indicator 854 to indicate to the user that the user can view additional information by interacting with the graphical indicator 854. While a drop-down box was described, this merely an example and the status graphical interaction 854 can include the ability to receive an input from the user indicate a specific status.

The GUI 800 has a search graphical interaction 860, a clear all graphical interaction 862, and a cancel interaction 864. The search graphical interaction 860 can perform the search requested by the user based on the selected criteria (e.g., the search graphical interaction 810, the transaction date graphical interaction 820, the claim date graphical interaction 830, the amount graphical interaction 840, and/or the status graphical interaction 850). The search may be completed by one or more devices. For example, the user device (e.g., user device 104, 106 of FIG. 1) may communicate with a server and/or database (e.g., the computing system 206 and/or enterprise system 206) to provide the search data based on the selected graphical interactions. The server and/or database may search the server and/or database based on the search data and provide the results to the user device. Alternatively, the user device can be capable of performing the search without interacting with the server and/or database. The clear all graphical interaction 862 can clear (e.g., empty, remove, etc.) all of the selected criteria. That is, the clear all graphical interaction 862 can reset the GUI 800 for the user. The cancel graphical interaction 864 can cancel the search and return the user to a previous screen (e.g., closes out the GUI 800 and opens another graphical user interface).

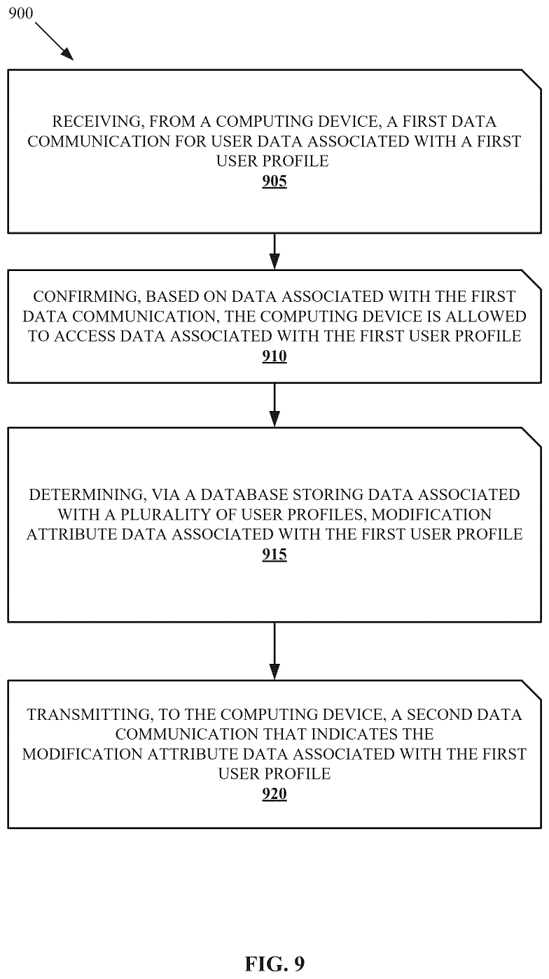

FIG. 9 depicts a block diagram of an example method 900 for tracking user requested modifications to data according to one embodiment. At block 905, the system receives, from a computing device, a first data communication for user data associated with a first user profile. The user data indicates one or more modifications to the first user profile. The first user profile is associated with a resource enterprise, and wherein the action to be taken on the first user profile comprises the resource enterprise modifying a resource value associated with the first user profile.

At block 910, the system confirms, based on data associated with the first data communication, the computing device is allowed to access data associated with the first user profile.

At block 915, the system determines, via a database storing data associated with a plurality of user profiles, modification attribute data associated with the first user profile. The modification attribute data indicates a status of the one or more modifications to the first user profile. The modification attribute data indicates one or more of a transaction date, a status progress, an account identifier, a request identifier, a description of the modification, a transaction amount, a request date, and/or a completion date

At block 920, the system transmits, to the computing device, a second data communication that indicates the modification attribute data associated with the first user profile. The computing device is configured to provide the modification attribute data to the user of the computing device.

The system can be further configured to determine, based on a third data communication indicating an update to the modification attribute data associated with the first user profile, that a first status of a first modification of the one or more modifications has changed to a second status of the first modification. The system can be further configured to update the database storing data associated with the plurality of user profiles to indicate the change from the first status to the second status. The system can be further configured to transmit, to a computing device, a fourth data communication indicating the second status of the first modification.

The system can be further configured to determine, via the database storing data associated with the plurality of user profiles, modification attribute data associated with the second user profile. The modification attribute data indicates a status of one or more modifications to the second user profile. The second data communication indicates the modification attribute data associated with the second user profile.

The system can be further configured to determine, based on the modification attribute data associated with the first user account, a graphical user interface (GUI) configured to display the modification attribute data associated with the first user profile. The system can be further configured to cause the GUI to be displayed on the computing device.

The system can be further configured to receive a third data communication indicating the first user completed the objective. The system determines, based on the first user completing the objective, a reward associated with completing the objective. The system updates the user profile attribute data associated with the user profile stored within the database to provide the first user with the reward. The system determines, based on the user profile attribute data associated with the user profile stored with the database, a new objective for the first user. The system transmits, to a user device associated with the second user, a fourth data communication indicating the new objective for the first user. The new objective can be determined based on demographic information associated with either the first user or the second user. The new objective can be based on one or more parameters determined by the second user to provide an incentive for the first user to complete one or more actions.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for datatype and file management, comprising:
at least one processor;
a communication interface communicatively coupled to the at least one processor; and
a memory device storing executable code that, when executed, causes the at least one processor to:
receive, from a computing device, a first data communication for user data associated with a first user profile, wherein the user data indicates one or more modifications to the first user profile;
confirm, based on data associated with the first data communication, the computing device is allowed to access data associated with the first user profile;
determine, via a database storing data associated with a plurality of user profiles, modification attribute data associated with the first user profile, wherein the modification attribute data indicates a status of the one or more modifications to the first user profile; and
transmit, to the computing device, a second data communication that indicates the modification attribute data associated with the first user profile, wherein the computing device is configured to provide the modification attribute data to the user of the computing device.

2. The system according to claim 1, wherein the memory device storing executable code that, when executed, further causes the at least one processor to:
determine, based on a third data communication indicating an update to the modification attribute data associated with the first user profile, that a first status of a first modification of the one or more modifications has changed to a second status of the first modification;
update the database storing data associated with the plurality of user profiles to indicate the change from the first status to the second status; and
transmit, to the computing device, a fourth data communication indicating the second status of the first modification.

3. The system according to claim 1, wherein the first data communication for user data associated with the first user profile further comprises user data associated with a second user profile, and wherein the memory device storing executable code that, when executed, further causes the at least one processor to:
determine, via the database storing data associated with the plurality of user profiles, modification attribute data associated with the second user profile, wherein the modification attribute data indicates a status of one or more modifications to the second user profile, wherein the second data communication indicates the modification attribute data associated with the second user profile.

4. The system according to claim 1, wherein the computing device is configured to provide the modification attribute data to the user of the computing device is further configured to:
determine, based on the modification attribute data associated with the first user account, a graphical user interface (GUI) configured to display the modification attribute data associated with the first user profile; and
cause the GUI to be displayed on the computing device.

5. The system according to claim 1, wherein the modification attribute data indicates one or more of a transaction date, a status progress, an account identifier, a request identifier, a description of the modification, a transaction amount, a request date, and/or a completion date.

6. The system according to claim 1, wherein the first user profile is associated with a resource enterprise, and wherein the action to be taken on the first user profile comprises the resource enterprise modifying a resource value associated with the first user profile.

7. The system according to claim 6, wherein a portion of the modification attribute data associated with the first user profile comprises data that the user is not allowed to access, and wherein the resource enterprise is allowed to access the portion of the modification attribute data.

8. A system for datatype and file management, comprising:
at least one processor;
a communication interface communicatively coupled to the at least one processor; and
a memory device storing executable code that, when executed, causes the at least one processor to:
transmit, from a computing device, a first data communication for user data associated with a first user profile, wherein the user data indicates one or more modifications to the first user profile, wherein the first data communications causes a determination, via a database storing data associated with a plurality of user profiles, of modification attribute data associated with the first user profile, wherein the modification attribute data indicates a status of the one or more modifications to the first user profile; and
receive, by the computing device, a second data communication that indicates the modification attribute data associated with the first user profile, wherein the computing device is configured to provide the modification attribute data to the user of the computing device.

9. The system according to claim 8, wherein the memory device storing executable code that, when executed, further causes the at least one processor to:
receive, by the computing device, a third data communication indicating an update to the modification attribute data associated with the first user profile from a first status to a second status.

10. The system according to claim 8, wherein the first data communication for user data associated with the first user profile further comprises user data associated with a second user profile, and wherein the memory device storing executable code that, when executed, further causes the at least one processor to:
receive, by the computing device, modification attribute data associated with the second user profile, wherein the modification attribute data indicates a status of one or more modifications to the second user profile, wherein the second data communication indicates the modification attribute data associated with the second user profile.

11. The system according to claim 8, wherein the memory device storing executable code that, when executed, further causes the at least one processor to:
determine, based on the modification attribute data associated with the first user account, a graphical user interface (GUI) configured to display the modification attribute data associated with the first user profile; and
cause the GUI to be displayed on the computing device.

12. The system according to claim 8, wherein the modification attribute data indicates one or more of a transaction date, a status progress, an account identifier, a request identifier, a description of the modification, a transaction amount, a request date, and/or a completion date.

13. The system according to claim 8, wherein the first user profile is associated with a resource enterprise, and wherein the action to be taken on the first user profile comprises the resource enterprise modifying a resource value associated with the first user profile.

14. The system according to claim 13, wherein a portion of the modification attribute data associated with the first user profile comprises data that the user is not allowed to access, and wherein the resource enterprise is allowed to access the portion of the modification attribute data.

15. A method for datatype and file management, comprising:
receiving, from a computing device, a first data communication for user data associated with a first user profile, wherein the user data indicates one or more modifications to the first user profile;
confirming, based on data associated with the first data communication, the computing device is allowed to access data associated with the first user profile;
determining, via a database storing data associated with a plurality of user profiles, modification attribute data associated with the first user profile, wherein the modification attribute data indicates a status of the one or more modifications to the first user profile; and
transmitting, to the computing device, a second data communication that indicates the modification attribute data associated with the first user profile, wherein the computing device is configured to provide the modification attribute data to the user of the computing device.

16. The method according to claim 15, further comprising:
determining, based on a third data communication indicating an update to the modification attribute data associated with the first user profile, that a first status of a first modification of the one or more modifications has changed to a second status of the first modification;
updating the database storing data associated with the plurality of user profiles to indicate the change from the first status to the second status; and
transmitting, to the computing device, a fourth data communication indicating the second status of the first modification.

17. The method according to claim 15, wherein the first data communication for user data associated with the first user profile further comprises user data associated with a second user profile, the method further comprising:
determining, via the database storing data associated with the plurality of user profiles, modification attribute data associated with the second user profile, wherein the modification attribute data indicates a status of one or more modifications to the second user profile, wherein the second data communication indicates the modification attribute data associated with the second user profile.

18. The method according to claim 15, wherein the computing device is further configured to:
determining, based on the modification attribute data associated with the first user account, a graphical user interface (GUI) configured to display the modification attribute data associated with the first user profile; and
cause the GUI to be displayed on the computing device.

19. The method according to claim 15, wherein the modification attribute data indicates one or more of a transaction date, a status progress, an account identifier, a request identifier, a description of the modification, a transaction amount, a request date, and/or a completion date.

20. The method according to claim 15, wherein the first user profile is associated with a resource enterprise, and wherein the action to be taken on the first user profile comprises the resource enterprise modifying a resource value associated with the first user profile.
